(19) United States
(12) Patent Application Publication
(10) Pub. No.: US 2004/0102118 A1
(43) Pub. Date: May 27, 2004

(54) High permeability woven members employing paired machine direction yarns for use in papermaking machine

(76) Inventors: Stewart Lister Hay, Ralmsbottom (GB); James Loy Brewster, Waskom, TX (US); John M. Thomas, Shreveport, LA (US); Jeffrey Bruce Herman, Bala Cynwyd, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/306,673

(22) Filed: Nov. 27, 2002

(51) Int. Cl. B32B 5/26

(52) U.S. Cl. 442/239; 442/206; 442/207; 442/181

(57) ABSTRACT

Multilayer woven fabrics include first and second machine direction layers, each machine direction layer including machine direction yarns extending in the machine direction of movement of the fabric through a section of a papermaking machine. One of the machine direction layers includes a plurality of pairs of contiguous machine direction yarns; each pair being spaced apart in the cross-machine-direction of the fabric from an adjacent pair and being in substantially vertically stacked alignment with a single machine direction yarn, or a pair of machine direction yarns in the other machine direction layer. A plurality of cross-machine-direction yarns, either single or paired, for binding the machine direction yarns extend in the cross-machine-direction of the fabric, are spaced apart in the machine direction of the fabric and are interwoven with the stacked machine direction layers to bind the single or paired machine direction yarns in one layer and the paired machine direction yarns in the other layer together in substantially vertically stacked alignment and to maintain that substantially vertically stacked alignment in the fabric during use.

### FIELD OF INVENTION

This invention relates generally to improved, high permeability woven members for use in papermaking machines. In the preferred embodiments, the members are employed to convey fibrous webs through the dryer section of a papermaking machine. Most preferably the woven members of the invention are carriers, or base fabrics for a resinous, embossing layer. In accordance with this invention, the woven members employ a unique woven structure to achieve numerous benefits.

### BACKGROUND OF THE INVENTION

High permeability fabrics are widely known in the papermaking art and are employed in various sections of a papermaking machine. One such fabrics, which preferably is employed in the dryer section of a papermaking machine, is disclosed in Gaisser U.S. Pat. No. 5,114,777. The woven fabric in Gaisser is a two-layer structure including pairs of vertically stacked, single warp yarns that are spaced apart from each other in the cross-machine-direction and are held together in their stacked relationship by a plurality of single weft yarns spaced along the machine direction of the fabric. Although, this fabric has been used commercially in dryer fabrics, improvements are desired in material costs, stability, seam strength and drainage or water extraction from fibrous webs without retention of excess water in the fabric.

Other multilayer papermaking fabrics employing weft binder yarns and being usable in various sections of a papermaking machine are disclosed in the prior art. For example, Stelljes, Jr. et al. U.S. Pat. No. 5,840,411 discloses a number of different embodiments of two-layer fabrics wherein each layer includes interwoven weft and warp yarns. These layers are connected together by tie yarns, which can be separate warp or weft yarns that are independent from the weave pattern in either layer, or warp or weft yarns that also contribute to the weave pattern in one or both of the layers. These structures employ two distinct layers, each including interwoven single warp and single weft yarns and are not directed to structures employing a plurality of paired warp yarns in the weave pattern.

The Stelljes, Jr. et al. '411 patent, in discussing background art in the paragraph bridging columns 3 and 4, refers generally to a structure in which a machine direction yarn is added between each pair of stacked machine direction yarns so that a single cross-machine-direction yarn tied together stacked machine direction yarns. This discussion does not allude to providing a plurality of pairs of machine direction yarns in a single layer to achieve any benefits whatsoever. In fact, the disclosed product, which is only vaguely described, was represented as being deficient by increasing pinholing in the formed paper web.

U.S. Pat. No. 4,995,529, issued to Kositzke, discloses a multilayer film including upper and lower, self-sustaining layers, each including interwoven machine direction and cross-machine-direction yarns. Although this patent discloses the vertical aligning of machine direction yarns in each layer, it does not relate in any way to structures including paired machine direction yarns in either layer.

U.S. Pat. No. 5,219,004, issued to Chiu, discloses multilayer structures employing bottom warp binder yarns. In one disclosed embodiment these bottom warp yarns are included in pairs, with each pair being located in a region underlying the open area between two, single top warp yarns. These disclosed fabrics are described as being usable in the wet end of a papermaking machine and are neither designed nor intended to be employed as a dryer fabric in such a machine. In particular, the fabrics disclosed in the Chiu '004 patent have a substantially lower open area than is desired or needed in dryer fabrics of papermaking machines. In fact, the top ply or layer of the Chiu structure preferably has twice as many shute yarns as in the bottom side, with the shute yarns on the bottom side underlying the open area between the shute yarns in the top ply. This impedes the flow of water through the fabric, and would be undesirable for use in dryer fabrics.

Other types of fabrics employing partner yarns are disclosed in Fitzka et al. U.S. Pat. No. 5,092,372. In these fabrics extra partner yarns are added to a top ply to vary the number of fiber supporting points in the fabric.

Other multilayer fabrics for use in papermaking machines are disclosed in U.S. Pat. Nos. 4,314,589 (Buchanan et al.); 4,501,303 (Osterberg); 4,705,601 (Chiu); 4,729,412 (Bugge); 4,832,090 (Krenkel et al.); 4,945,952 (Vohringer); 5,054,525 (Vohringer); 5,151,316 (Durkin et al.) and 5,152,326 (Vohringer).

Applicants believe that a need exists for improved, high permeability, woven members in papermaking machines; preferably in dryer fabrics, and more particularly in through air dryer (TAD) fabrics, which have excellent seam strength, excellent stability, high drainage and lower water retention properties than prior art dryer fabric structures and that are capable of supporting, or receiving a cast, resinous, embossing layer employing less resinous material than prior art structures. It is to such woven members and composite dryer fabrics employing same that the present invention is directed.

### SUMMARY OF THE INVENTION

The above and other objects of this invention are achieved in a multilayer woven fabric including first and second layers, each including yarns extending in the machine direction of movement of the fabric through a section of papermaking machine.

Most preferably, the fabrics of this invention are formed in a flat weaving process, resulting in the warp yarns being disposed in the machine direction of fabric movement through a section of a papermaking machine and the weft yarns being disposed transversely to the warp yarns, i.e., in the cross-machine-direction of the papermaking machine. Although it may be difficult to form the fabrics of this invention in an endless weaving process, if such a process is employed, then the weft yarns will be disposed in the machine direction of fabric movement through a section of a papermaking machine and the warp yarns will be disposed transversely to the weft yarns, i.e., in the cross-machine-direction of the papermaking machine. In accordance with the broadest aspect of this invention the fabrics may be formed by either a flat weaving process or an endless weaving process; although the flat weaving process is preferred.

Reference throughout this application, including the claims, to fabrics having yarns being in the “machine direction” refers to the direction of such yarns on a papermaking machine; not on a loom employed to manufacture the fabrics. Similarly, reference throughout this application to fabrics having yarns being in the “cross-machine-direction” refers to the direction of such yarns on a papermaking machine; not on a loom employed to manufacture the fabrics.

For ease of discussion, throughout this application flat woven fabrics of this invention will be described, wherein the first and second layers are warp layers; each including warp yarns extending in the machine direction. However, as stated above, in endless woven fabrics of this invention weft yarns will extend in the machine direction and warp yarns will extend in the cross-machine-direction.

In accordance with this invention, one of the warp layers includes a plurality of pairs of contiguous warp yarns, said pairs being spaced apart in the cross-machine-direction of the fabric, each pair being in stacked, substantially vertical alignment with a single warp yarn, or optionally with paired warp yarns in the other warp layer. One of the layers is a paper side layer adapted to support a paper web thereon and the other layer is a machine, or wear side layer in contact with vacuum boxes, drive rolls, etc. In accordance with this invention the number of single, or if desired paired warp yarns in one of said warp layers equals the number of pairs of warp yarns in the other warp layer, whereby the stacked, substantially vertical alignment of the single or paired warp yarns in one layer with the paired warp yarns in the other layer permits substantially unimpeded air flow through both layers of the fabric; an attribute that is highly desirable, and indeed required in through air dryer (TAD) fabrics.

The warp yarns in each pair of warp yarns preferably contact each other along a tangent line, but in some cases may be slightly spaced apart due to slight movement occurring during the weaving operation, or in use of the fabric. However, in all cases the space between adjacent pairs of warp yarns is substantially larger than any spacing that might exist between the yarns in each pair.

Reference throughout this application to “substantially” or “substantial” in describing the vertical alignment or vertical arrangement of a single or pair of warp yarns in one layer with a pair of warp yarns in the other layer includes a relationship wherein the warp yarns in one layer are in precise vertical alignment with the warp yarns in the other layer, as well as an arrangement wherein a single warp yarn or paired warp yarns in one layer at least partially overlie (or partially underlie) a pair of warp yarns in the other layer. For example, when a single warp yarn in one layer is in precise vertical alignment with a pair of warp yarns in the other layer, the central axis of the single warp yarn is in generally vertical alignment with the line of contact, or contiguous line or region between the paired warp yarns. However, a single warp yarn, or optionally a pair of warp yarns in one layer is (are) “substantially” in vertical alignment with a pair of warp yarns in the other layer even if it (they) is (are) offset in a lateral direction to only partially overlap with one or both of the warp yarns in the underlying or overlying pair of warp yarns in the other layer. For example, a single warp yarn in one layer may overly at least a part of each of the warp yarns in an underlying or overlying pair of warp yarns at different machine direction locations along said warp yarns. This can result from the lateral crimping of the warp yarns by the binding weft yarn and also as a result of manufacturing tolerances in forming the fabrics of this invention. In accordance with the broadest aspects of this invention there must be sufficient overlap between the warp yarns in the respective layers to maintain the two layers separated when such layers are bound by weft binder yarns and also to maintain a desired unimpeded path for fluid flow through the fabric. Thus, unlike prior art constructions employing precisely vertically aligned, single warp yarns in opposed first and second layers, it is much easier to maintain the desired substantial vertical alignment in the fabrics of this invention, wherein the warp yarns in at least one layer are disposed in pairs.

In the preferred embodiments, both the single or paired warp yarns in one of the warp layers and the paired warp yarns in the other warp layer are spaced-apart in the cross-machine-direction to provide a desired projected fabric open area in both the paper side layer and the wear side layer to permit the unimpeded passage of air therethrough when the fabric is employed in the dryer section, e.g., TAD section, of a papermaking machine. Preferably, the projected open area in both the paper side layer and the wear side layer is at least 25%; more preferably at least 30% and most preferably close to 35%. In fact, in the most preferred embodiments of the invention the projected open area in the paper side layer is in excess of 40% and in some constructions in excess of 50%.

In accordance with the most preferred embodiments of this invention the projected open area in one of the layers is different than the projected open area in the other layer. This results from the spaced apart warp yarns in one layer having a different diameter, or transverse dimension parallel to the plane of the fabric than the transverse dimension of substantially vertically aligned pairs of warp yarns in the other layer. In one preferred embodiment of this invention the paper side layer includes spaced-apart single warp yarns substantially vertically overlying paired warp yarns in the wear side layer; thereby resulting in a fabric having a higher projected open area in the paper side layer than in the wear side layer. However, in accordance with this invention the layers can be reversed, i.e., the paper side layer having paired warp yarns and the lower projected open area therein.

The difference in projected open areas in the two layers may provide advantages in controlling air flow through the fabric. In addition, providing a lower projected open area in one of the layers may permit the use of less resin in casting an embossing layer on the fabric to achieve a desired porosity through the fabric. In other words, since the projected open area in one of the layers is less than the projected open area in the other layer, less resin will be required in the lower projected open area region to achieve a desired air permeability, as compared to the amount of resin required to achieve that same level of air permeability in a region of the fabric having a higher projected open area prior to casting. The use of less resin results in a desirable reduction in material costs.

A plurality of warp binding weft yarns, which can be either single or paired weft yarns, are spaced apart in the machine direction of the fabric and are interwoven with the stacked warp layers to bind the single or paired warp yarns in one layer and the paired warp yarns in the other layer together in a stacked, substantially vertically aligned arrangement and to maintain that stacked substantially vertical alignment in the fabric during use.

When the weft binder yarns are in spaced-apart pairs, the projected open area through both warp layers will be reduced as compared to utilizing spaced-apart single weft binder yarns, if the transverse dimension of the paired yarns is greater than the diameter, or transverse dimension of the single weft binder yarns. Thus, the use of spaced-apart paired weft yarns as opposed to spaced-apart single weft yarns may permit the use of less resin in casting an embossing layer on the fabric to achieve a desired projected open area through the composite structure; resulting in a savings in material costs; however, possibly at the expense of reduced fluid permeability.

The fabrics of this invention have increased fabric mass and lower caliper than comparable two-layer structures employing vertically stacked, single warp yarns. This results in a structure that is extremely stable and retains less water for rewetting fibrous webs carried thereon. Moreover, in applications in which the fabric is employed as a carrier for a resinous embossing layer cast thereon, e.g., when such a composite fabric is employed in a dryer section of a papermaking machine and in particular a TAD section, the lower caliper structure permits the use of less resinous material in the resinous embossing layer, thereby lowering material costs.

Moreover, the caliper of the composite structure also is less, thereby reducing the amount of water being carried with the composite fabric. This is highly advantageous in dryer fabrics, and in particular TAD fabrics, since by reducing the amount of water carried into the dryer section by the fabric, less energy is required to dry the fibrous webs carried on such composite fabrics. This provides a potential savings in energy in operating the papermaking machine.

In a preferred form of this invention, the above described, multilayer member is a carrier fabric for a resinous embossing layer thereon, such as a layer of the type disclosed in FIGS. 2 and 3 of the aforementioned Gaisser '777 patent, but of a lower weight and cost. The subject matter of the Gaisser '777 patent is fully incorporated herein by reference, it being understood that the specific resinous embossing layer is a structure well-known to those skilled in the art and does not constitute a separate and independent invention of the present applicants. In fact, representative constructions employing a cast, resinous framework on a woven carrier fabric are disclosed in U.S. Pat. Nos. 4,514,345, issued to Johnson et al.; 4,528,239, issued to Trokhan; 4,529,480, issue to Trokhan and 4,637,859, issued to Trokhan. The subject matter in these latter four patents is fully incorporated herein by reference.

### BRIEF DESCRIPTION OF THE DRAWINGS

FIG. 1 is a schematic view showing a through air dryer section of a papermaking machine in which fabrics of this invention can be employed;

FIG. 2 is a partial plan view of a fabric in accordance with this invention showing the interwoven construction of the top and bottom warp layers with the warp binding weft yarns;

FIGS. 3A-3D are vertical sectional views along lines 3A-3A through 3D-3D, respectively, of FIG. 2; and

FIG. 4 is a plan view schematically illustrating the multilayer fabric of FIG. 2 as a carrier fabric for a resinous, embossing top layer to form a composite dryer fabric.

### DESCRIPTION OF THE BEST MODES OF THE INVENTION

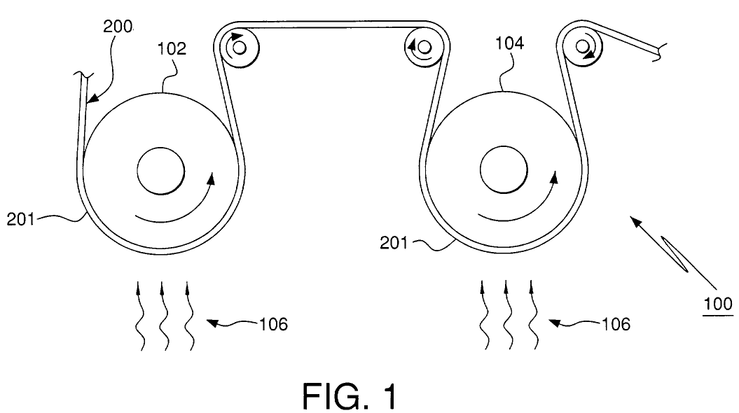

Referring to FIG. 1, a dryer section of a papermaking machine and in particular a TAD dryer section is schematically illustrated at 100. This section includes a unique dryer fabric 200 in accordance with this invention, which is trained about a pair of open mesh cylinders 102, 104. A hood (not illustrated) overlies the cylinders for directing hot air through a paper web 201 and the dryer fabric 200 carrying the paper web thereon, in the direction illustrated by arrows 106. The hot air passing through the dryer fabric 200 moves into the rolls 102, 104 and is then re-circulated into and through the hood section, in a well-known manner. Although a schematic view of a TAD section is shown it should be understood that this is for illustrative purposes only and that the dryer section employing the fabrics of this invention can be of any desired type, including, but not limited to, a dryer section of the type schematically disclosed in the aforementioned Gaisser '777 patent, the subject matter of which already has been incorporated herein by reference in its entirety. Moreover, the fabric 200 may have applications in sections of a papermaking machine other than a dryer section, such as in the forming section or in a press section. However, the mesh, count and/or diameter of the yarns may need to be varied for different uses of the fabrics of this invention. In a press section, the woven member is a base fabric of a press felt having a fibrous batt that preferably is needled therein, in a manner well known in the art.

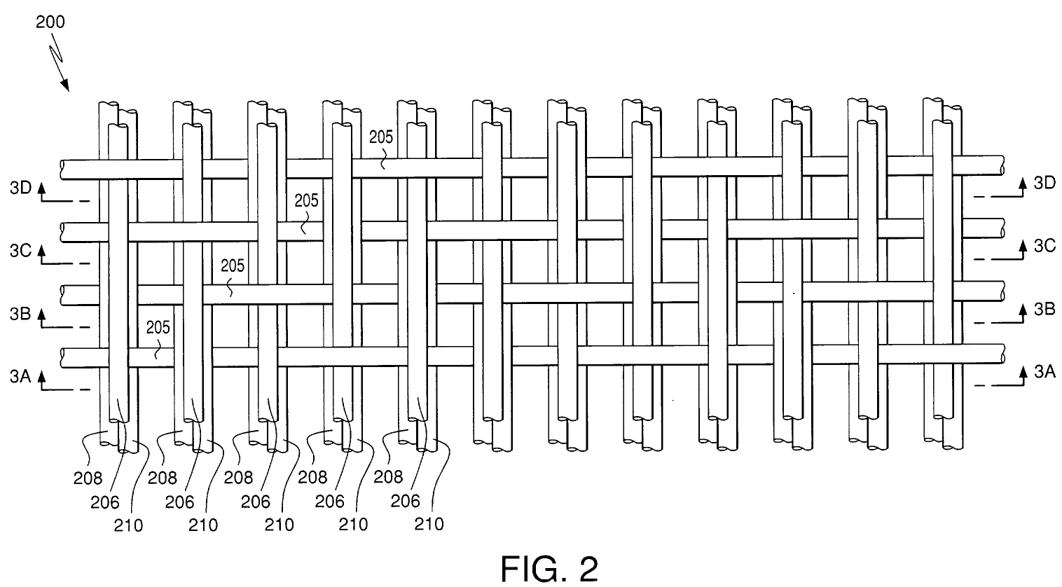

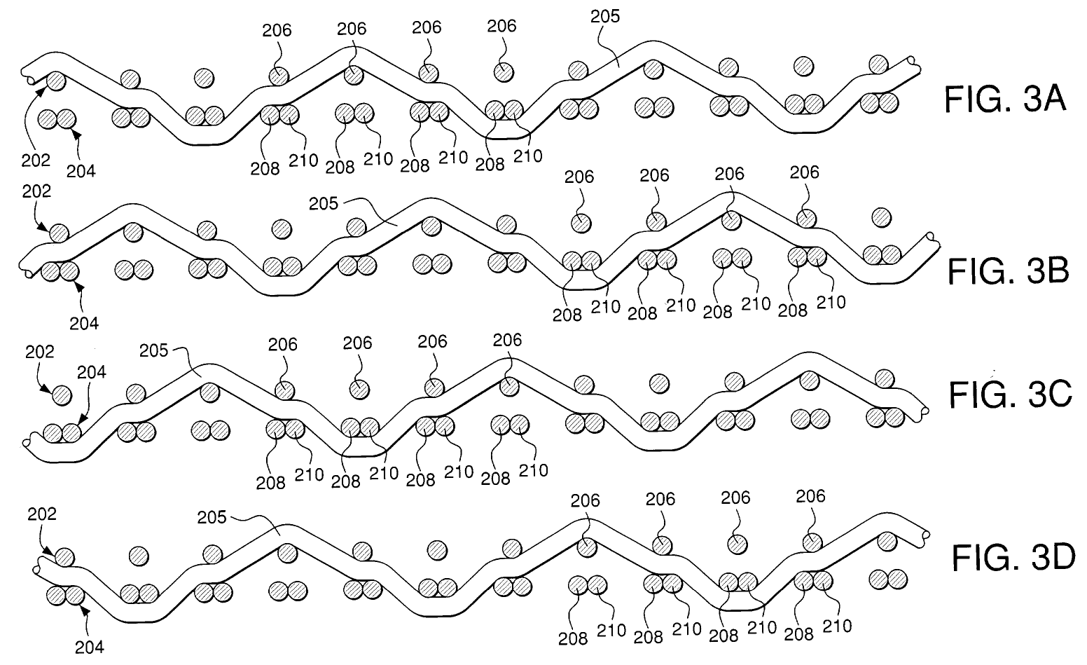

Referring to FIGS. 2 and 3, a woven fabric 200 in accordance with one embodiment of this invention will be described in connection with its use in a dryer section, and more particularly a TAD section of a papermaking machine, it being understood that in accordance with the broadest aspects of the invention the fabric 200 may be usable in other sections of a papermaking machine. The fabric 200 in accordance with this invention includes top and bottom warp layers 202 and 204, with the warp yarns in each layer extending in the machine-direction of movement of the fabric through the papermaking machine. In this preferred embodiment, the top layer is the paper side layer for contacting a paper web and the bottom layer is a wear side layer for contacting vacuum boxes, drive rolls, and the like. In addition, the fabric 200 includes a plurality of warp binding weft yarns 205 extending in the cross-machine-direction and being spaced apart in the machine direction for interconnecting the top and bottom warp layers 202 and 204 together.

As can be seen in FIGS. 2 and 3, the top warp, paper side layer 202 includes single warp yarns 206 that are spaced-apart in the cross-machine-direction to provide a desired projected open area through the paper side layer of the fabric; most preferably of at least 25% to permit the desired passage of air therethrough when the fabric is employed in TAD section of a papermaking machine. More preferably the projected open area in the paper side layer 202 is at least 30%; more preferably at least 35% and most preferably in excess of 40%. For some applications the projected open area in the paper side layer 202 exceeds 50%.

In the illustrated embodiment, the bottom, or wear side warp layer 204 includes a plurality of pairs of machine direction warp yarns; the yarns in each pair being designated 208, 210. As can be seen best in FIGS. 3A-3D, the machine direction warp yarns 208, 210 in each pair are contiguous to each other and are aligned in a transverse direction generally parallel to the plane of the fabric 200.

Referring to FIGS. 2 and 3A-3D, the pairs of warp yarns 208, 210 in the bottom warp layer 204 are spaced-apart in the cross-machine-direction so that each pair of warp yarns is substantially vertically aligned under a corresponding warp yarn 206 in the top warp layer 202. In the illustrated embodiments of this invention the projected open area in the wear side layer 204 is less than the projected open area in the paper side layer 202; resulting from the transverse dimension of each of the paired warp yarns in the wear side layer, in the direction of the plane of the fabric being greater than the diameter of the single warp yarns 206 in the paper side layer 202. Preferably, in this embodiment of the invention the projected open area of the wear side layer 204 is at least 25%; more preferably at least 30% and most preferably close to 35%. For some applications the projected open area in the wear side layer exceeds 35%.

As can be seen best in FIGS. 3A-3D, twelve (12) warp yarns are woven in a twelve shed, four repeat pattern with a single weft system, including the plurality of weft yarns 205 spaced along the machine direction of the fabric. This is in distinction to the prior art structure disclosed in the Gaisser '777 patent, which is woven in an eight shed, four repeat pattern. This provides increased mass in the fabrics of this invention, resulting in a stable construction that does not excessively stretch in use.

The weft yarns 205 are woven in four picks, as illustrated in FIGS. 3A-3D, respectively. That is, the weave sequence repeats every four picks, e.g., picks 1 and 5 pass over, between, and under the same warp yarns; picks 2 and 6 pass over, between and under the same warp yarns, etc. it should be noted that the warp binder weft yarns 205 interweave with the substantially vertically stacked single warp yarns and underlying pairs of bottom warp yarns in such a manner that they maintain the single warp yarns and paired warp yarns in their respective paper side layer 202 and wear side layer 204. In particular, the warp binding weft yarns 205 maintain the substantial vertical alignment by preventing the top warp yarns 206 and underlying pairs of bottom warp yarns 208, 210 from shifting excessively relative to each other in a lateral direction.

As can be seen best in FIGS. 3A-3D, the over, between, under, between repeat pattern of the adjacent picks of the warp binding weft system binds the top and bottom warp yarns into the illustrated, substantially vertically stacked arrangement and maintains that stacked arrangement in the use of the fabric 200 of the invention.

It should be noted that variations in the above-described weave pattern can be employed, provided that the weave pattern is capable of maintaining the substantially vertically stacked relationship of each of the top warp yarns 206 with a corresponding pair of bottom warp yarns 208, 210. Some of these variations are disclosed in the Gaisser '777 patent, which already has been fully incorporated by reference herein.

In a representative embodiment of the invention, the warp yarns 206, 208 and 210 in the top and bottom warp layers 202, 204 are of the same diameter, e.g., approximately 0.16 millimeters. However, it is within the scope of the invention to employ different diameter yarns in the top and bottom warp layers, and also to vary the cross-sectional shape of the warp yarns, e.g., ovate, square, rectangular, etc. For example, the top warp yarns 206 can have a diameter of 0.22 mm and the paired, lower warp yarns can each have a diameter of 0.16 mm . As stated earlier, by employing paired warp yarns in one of the layers the number of yarns in each repeat of the weave pattern is 12, as opposed to 8 in a conventional, prior art structure employing vertically stacked, single warp yarns in each of the top and bottom layers. This provides increased mass, resulting in a stable construction that does not excessively stretch in use. Moreover, in view of the fact that paired warp yarns are disposed in transverse alignment within one of the layers, parallel to the general plane of the fabric 200, those warp yarns provide the desired enhanced mass without undesirably increasing the caliper of the fabric.

In fact, in a fabric 200 of this invention employing 0.22 mm top warp yarns 206 (35/inch), 0.16 mm bottom warp yarns 208, 210 in each bottom pair of warp yarns (35 pairs/inch), and binding weft yarns 205 having a diameter of 0.28 mm (35/inch), the calculated mass of the fabric, disregarding the effect that crimping of the warp yarns can have on increasing fabric mass, is increased approximately 8.5% and the calculated caliper, or thickness, is reduced in the range of approximately 8%-13%, as compared to a prior art structure in which both the top and bottom warp yarns are single warp yarns having a diameter of 0.22 mm (both 35/inch) and the binding weft yarns have a diameter of 0.28 mm (30/inch). This reduction in caliper permits the use of less resin in casting an embossing layer thereon, as was described earlier herein.

A further advantage of employing paired warp yarns is that a limited, additional air cavity exists between the yarns in each of the pairs to further enhance air flow through the fabric 200.

Moreover, in the above-described structure the projected open area in the top, paper side layer 202 is approximately 42.8% and the projected open area in the bottom, wear side layer 204 is approximately 34.3%. Thus the ratio of wear side to paper side projected open area is approximately 1.25. The variation in projected open area in the paper side and wear side layers may provide a benefit in controlling air flow through the fabric. Moreover, as was explained earlier, less resin may be required to form an embossing layer on the fabric 200 to achieve a desired fluid permeability through the fabric, than would be required if the projected open area in the wear side layer 204 was at the same higher percentage as in the paper side layer. That is, the larger the starting projected open area in the wear side layer of the carrier fabric the more resin that is required to achieve a desired projected open area in the wear side layer of the composite fabric including the embossing layer thereon. The more resin that is required, the higher the material cost.

The use of weft binder yarns 205 having a larger diameter than the warp yarns in both the top and bottom layers 202, 204, provides enhanced cross directional fabric stability. In fact, this is a preferred construction in this invention. In addition, the larger diameter weft yarns provide a stiffer weft yarn that places more crimp in the warp yarns. This results in a distinct advantage when the ends of the fabric are joined together in an endless manner at a seam. Specifically, as is well known, highly crimped warp yarns are more easily interwoven together in the endless fabric and interlocked at the seam to enhance seam strength. However, it is within the scope of the broadest aspects of this invention to employ weft yarns that are of the same, or smaller diameter than the diameter of the warp yarns in the paper side layer and/or the wear side layer.

In another exemplary embodiment of a fabric 200 in accordance with this invention, the diameter of the warp yarns in the top layer 202 is 0.16 mm (35/inch) and the diameter of the binding weft yarns 205 is 0.22 mm (35/inch). The yarns of the paired bottom warp yarns are the same as in the previously-described embodiment; each having a diameter of 0.16 mm (35 pairs/inch). In this embodiment, the mass of the fabric is approximately 24% lower than the previously described prior art structure including binding weft yarns of 0.28 millimeters (30/inch) and vertically stacked, single top and bottom warp yarns (35/inch) each having a diameter of 0.22 millimeters. For some applications this may be acceptable; particularly in view of the approximately 27% reduction in caliper and the high air permeability, e.g., approximately 1150 cfm, achieved in this embodiment of the invention. This low caliper structure permits a resinous embossing layer to be cast thereon with the use of less resin, and therefore at a lower material cost, than in prior art, higher caliper structures.

In this second exemplary embodiment, like the first exemplary embodiment, the projected open area in the paper side layer is greater than the projected open area in the wear side layer. Specifically, the projected open area in the paper side layer is approximately 54.3% and the projected open area in the wear side layer is approximately 39%. Thus the ratio of wear side to paper side projected open area is approximately 1.39. These higher projected open areas than in the first exemplary embodiment may be highly desirable in applications requiring high air flow; particularly in high speed TAD applications. Moreover, the lower projected open area of the wear side layer relative to the paper side layer should result in the use of less resin to achieve a desired permeability in a composite fabric including a resinous embossing layer thereon, than if the projected open area in the wear side layer was at the same high percentage as the projected open area in the paper side layer.

It should be noted that in the fabrics of this invention the mesh, count, and diameter of the machine direction yarns in the two layers can be varied to provide a desired projected open area in each of the top and bottom layers. For certain applications, it may be more beneficial to provide a lower projected open area in the top layer than in the bottom layer. For example, in a composite fabric employing a cast, resinous embossing layer thereon it may be desirable to provide a greater area of fabric contact with the sheet on the top side of the fabric in the open areas of the resinous layer. This can be achieved by providing a lower projected open area in the top, paper side layer than in the bottom, wear side layer, for example by including paired warp yarns in the top layer and single warp yarns in substantially vertically underlying relationship with each set of paired warp yarns, or by otherwise adjusting the mesh, count and/or diameter of the yarns in the respective layers.

Regardless whether the projected percentage open area is greater in the wear side or paper side layer, by employing different projected percentage open areas in the respective layers a cost benefit is derived by utilizing less resinous material to form a composite fabric with a cast, resinous embossing layer thereon. In particular, less resin is required to achieve a desired permeability in a composite fabric including a resinous embossing layer thereon than if the projected open area of the layer having the lower projected open area was increased to the same high percentage as the projected open area in the other layer.

In accordance with this invention, the fabric needs to have an adequate modulus to preclude undesired stretching of the fabric in use, and an adequate seam strength to maintain the integrity of the fabric by preventing it from pulling apart in use. Normally, the straighter the yarns, the higher the modulus. However, the greater the crimp included in the machine direction yarns, the better the seam strength. Accordingly, there is a need to achieve a desired balance of these properties, which can be effected, in part, by heat setting the yarns during the fabric forming operation.

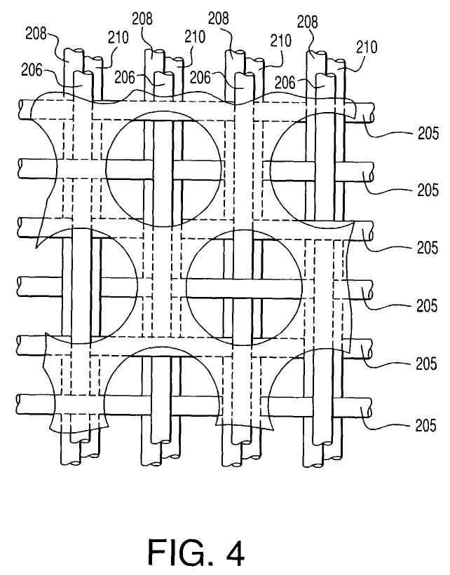

Various combinations of materials and yarn diameters and shapes can be employed in this invention. In particular the warp yarns employed in the top layer can be the same or different than the warp yarns that are paired together in the bottom layer, either in material, diameter or shape; a suitable material for forming the fabric including polyphenylene sulfide, which is a high temperature-resistant, UV transparent resin. However, it is within the scope of this invention to utilize other resins in the yarns of this invention, such as, but not limited to polyketones (e.g., PEEK), polyethylene napthalate (i.e. PEN) and polyester; the particular material employed to form the yarns utilized in the fabrics of this invention not constituting a limitation on the broadest aspects of this invention. However, most preferably the materials employed in the fabrics of this invention have high temperature, hydrolysis and dry heat resistance. UV transparent yarns are highly desirable in structures including a cast, UV curable resinous layer thereon (e.g., a resinous layer 400 as illustrated in FIG. 4), to permit the UV curing of the resinous layer to the woven fabric. This is well known in the art, and therefore no further explanation is provided herein.

Also, although the illustrated embodiment of this invention includes the paired warp yarns in the bottom warp layer 204, it is within the broader aspects of this invention to include the paired warp yarns in the top warp layer 202 and the single warp yarns in the bottom warp layer stacked vertically under the pairs of warp yarns in the top warp layer. Moreover, it is within the scope of this invention to include paired warp yarns in both the top layer 202 and bottom layer 204, although this will result in a reduction of the open area through the fabric, which might not be acceptable for all desired applications.

It also is within the broadest aspects of this invention to employ pairs of contiguous yarns as binding weft yarns, instead of the single weft yarns 205 described above. Preferably, when paired weft yarns are employed, the yarns in each pair preferably follow the same weave pattern. The use of paired wefts could provide a greater reduction in caliper; permitting the use of even a lower amount of resin in the casting of an embossing layer thereon, e.g., see layer 400 in FIG. 4. Moreover, by using paired warp yarns having a combined transverse dimension in the plane of the fabric that is greater than the diameter, or transverse dimension of corresponding, spaced-apart single weft binder yarns, the percent projected open area through the fabric is reduced, thereby further lowering the amount of resin required to cast an embossing layer thereon to achieve a desired permeability in the composite structure; however, possibly at the expense of desired fluid permeability.

While the term yarn has been used throughout the application, it is to be understood that the term yarn encompasses a monofilament element or elements as well as a multifilament element or elements.

Referring to FIG. 4, the fabric 200 is illustrated as a carrier, or base fabric for a cast resinous embossing layer 400. Although this composite structure has a lower permeability than the woven structure without the resinous layer, the permeability is still sufficient for many drying applications. The specific decrease of air permeability between the base fabric without the resinous layer and the base fabric with the resinous layer thereon depends on the size, shape, and pattern of holes 402 in the resinous layer. To reiterate, it should be understood that the fabrics of this invention may be utilized in other papermaking applications, such as a press felt with a fibrous batt needled therein, or if the weave pattern is fine enough, as a forming fabric in the forming section of a papermaking machine.

Without further elaboration, the foregoing will so fully illustrate my invention that others may, be applying current or further knowledge, readily adopt the same for use under various conditions of service.

What we claim as our invention is the following:

1. A multilayer woven fabric for use in a papermaking machine, said fabric including first and second layers, each layer including a plurality of machine direction yarns; one of said layers including a plurality of single machine direction yarns spaced-apart in a cross-machine-direction to provide a desired projected open area in said one layer; the other of said layers including a plurality of pairs of contiguous machine direction yarns, said pairs being spaced apart in the cross-machine-direction to provide a desired projected open area in said other of said layers, each pair being in substantially vertically stacked alignment with the single machine direction yarn in the one of said layers, and a plurality of cross-machine-direction yarns being spaced apart in the machine-direction and being interwoven with the machine direction yarns in said first and second layers to bind together the single machine direction yarns in said one of said layers and the paired machine direction yarns in the other of said layers to establish and maintain each single machine direction yarn in a substantially vertically stacked relationship with a corresponding pair of machine direction yarns to maintain a desired projected open area through each of said first and second layers of said fabric.

2. The multilayer fabric of claim 1, wherein said one of said layers includes an outer surface for supporting a fibrous web being directed through a section of the papermaking machine, said other of said layers engaging drive rolls for moving said fabric in the machine-direction through a section of the papermaking machine.

3. The multilayer fabric of claim 2, wherein said section of the papermaking machine is a dryer section.

4. The multilayer fabric of claim 3, wherein said dryer section is a through air dryer section.

5. The multilayer fabric of claim 2, wherein the single machine direction yarns in said one layer and the machine direction yarns in each of the paired machine direction yarns in said other layer being of the same diameter, said cross-machine-direction yarns being of a different diameter than the diameter of said machine direction yarns.

6. The multilayer fabric of claim 2, wherein the single machine direction yarns in said one layer have a greater diameter than the diameter of each of the machine direction yarns in each of the paired machine direction yarns of said other layer, the machine direction yarns in all of said pairs of machine direction yarns being of the same diameter, said cross-machine-direction yarns being of a different diameter than the diameter of said machine direction yarns in said first and second layers.

7. The multilayer fabric of claim 5, wherein said cross-machine-direction yarns have a diameter greater than the diameter of the machine direction yarns in said first and second layers.

8. The multilayer fabric of claim 6, wherein said cross-machine-direction yarns have a diameter greater than the diameter of the machine direction yarns in said first and second layers.

9. The multilayer fabric of claim 1, having at least a 25% projected open area in each of said first and second layers.

10. The multilayer fabric of claim 2, having at least a 25% projected open area in each of said first and second layers.

11. The multilayer fabric of claim 3, having at least a 25% projected open area in each of said first and second layers.

12. The multilayer fabric of claim 4, having at least a 25% projected open area in each of said first and second layers.

13. The multilayer fabric of claim 1, wherein said cross-machine-direction yarns have a four pick repeat.

14. The multilayer fabric of claim 2, wherein said cross-machine-direction yarns have a four pick repeat.

15. The multilayer fabric of claim 3, wherein said cross-machine-direction yarns have a four pick repeat.

16. The multilayer fabric of claim 4, wherein said cross-machine-direction yarns have a four pick repeat.

17. The multilayer fabric of claim 1, wherein said cross-machine-direction yarns have a twelve shed, four pick repeat.

18. The multilayer fabric of claim 2, wherein said cross-machine-direction yarns have a twelve shed, four pick repeat.

19. The multilayer fabric of claim 3, wherein said cross-machine-direction yarns have a twelve shed, four pick repeat.

20. The multilayer fabric of claim 4, wherein said cross-machine-direction yarns have a twelve shed, four pick repeat.

21. The multilayer fabric of claim 1, wherein said plurality of cross-machine-direction yarns includes single cross-machine-direction yarns being spaced apart from each other in the machine direction.

22. The multilayer fabric of claim 1, wherein said plurality of cross-machine-direction yarns are arranged in pairs of contiguous yarns, said pairs of contiguous cross-machine-direction yarns being spaced apart from each other in the machine direction.

23. The multilayer fabric of claim 1, wherein said machine direction yarns are warp yarns and said cross-machine-direction yarns are weft yarns.

24. The multilayer fabric of claim 1, wherein said machine direction yarns are weft yarns and said cross-machine-direction yarns are warp yarns.

25. The multilayer fabric of claim 1, wherein the projected open area in said one of said layers is greater than the projected open area in the other of said layers.

26. The multilayer fabric of claim 25, wherein the projected open area in said one of said layers is greater than 40% and the projected open area in the other of said layers is at least 25%.

27. The multilayer fabric of claim 25, wherein the projected open area in said one of said layers is greater than 50% and the projected open area in the other of said layers is at least 25%.

28. The multilayer fabric of claim 26, wherein the projected open area in the other of said layers is at least 30%.

29. The multilayer fabric of claim 27, wherein the projected open area in the other of said layers is at least 35%.

30. The multilayer fabric of claim 1, wherein the single warp yarn in one layer overlies or underlies at least a part of each of the warp yarns in an underlying or overlying pair of warp yarns at different machine direction locations along said warp yarns.

31. A multilayer woven fabric for use in a dryer section of a papermaking machine, said fabric including first and second layers, each layer including a plurality of machine direction yarns; said first layer including a plurality of single machine direction yarns spaced-apart in a cross-machine-direction to provide a desired projected open area in said one layer; the second layer including a plurality of pairs of contiguous machine direction yarns, said pairs being spaced apart in the cross-machine-direction to provide a desired projected open area in said second layer, each pair being in substantially vertically stacked alignment with the single machine direction yarn in the first layer and a plurality of cross-machine-direction yarns being spaced apart in the machine direction and being interwoven with the machine direction yarns in said first and second layers to bind together the single machine direction yarns in said first layer and the paired machine direction yarns in the second layer to establish and maintain each single machine direction yarn in a substantially vertically stacked relationship with a corresponding pair of machine direction yarns to maintain a desired projected open area through each of said first and second layers of said fabric, further including a resinous embossing layer adhered to said fabric and including an upper surface for contacting a fibrous web being transported through said dryer section.

32. The multilayer fabric of claim 31, wherein said dryer section is a through air dryer section.

33. The multilayer fabric of claim 31, wherein the projected open area in said one of said layers is greater than the projected open area in the other of said layers prior to including the resinous embossing layer on the fabric.

34. The multilayer fabric of claim 31, wherein the projected open area in said one of said layers is greater than 40% and the projected open area in the other of said layers is at least 25% prior to including the resinous embossing layer on the fabric.

35. The multilayer fabric of claim 31, wherein the projected open area in said one of said layers is greater than 50% and the projected open area in the other of said layers is at least 25% prior to including the resinous embossing layer on the fabric.

36. The multilayer fabric of claim 34, wherein the projected open area in the other of said layers is at least 30% prior to including the resinous embossing layer on the fabric.

37. The multilayer fabric of claim 35, wherein the projected open area in the other of said layers is at least 35% prior to including the resinous embossing layer on the fabric.

38. The multilayer fabric of claim 31, wherein the single warp yarn in one layer overlies or underlies at least a part of each of the warp yarns in an underlying or overlying pair of warp yarns at different machine direction locations along said warp yarns.

39. A multilayer woven fabric for use in a papermaking machine, said fabric including first and second layers, each layer including a plurality of pairs of machine direction yarns; the yarns in each pair of yarns being contiguous to each other, each pair of machine direction yarns in said first layer being spaced-apart from adjacent pairs of machine direction yarns in a cross-machine-direction to provide a desired projected open area in said first layer; the pairs of machine direction yarns in said second layer being spaced apart from adjacent pairs of machine direction yarns in the cross-machine-direction to provide a desired projected open area in said second layer, each pair of machine direction yarns in said first layer being in substantially vertically stacked alignment with a corresponding pair of machine direction yarns in said second layer and a plurality of cross-machine-direction yarns being spaced apart in the machine-direction and being interwoven with the pairs of machine direction yarns in said first and second layers to bind together the paired machine direction yarns in said first layer and the paired machine direction yarns in the second layer to establish and maintain each pair of machine direction yarns in said first layer in a substantially vertically stacked relationship with a corresponding pair of machine direction yarns in the second layer to maintain a desired open area through each of said first and second layers of said fabrics.

40. The multilayer fabric of claim 38, wherein said first layer includes an outer surface for contacting a fibrous web being directed through a section of the papermaking machine, said second layer engaging drive rolls for moving said fabric in the machine-direction through said section of the papermaking machine.

41. The multilayer fabric of claim 39, wherein said section of the papermaking machine is a dryer section.

42. The multilayer fabric of claim 40, wherein said dryer section is a through air dryer section.

43. The multilayer fabric of claim 39, wherein all of the machine direction yarns in both layers are the same diameter, said cross-machine-direction yarns being of a different diameter than the diameter of said machine direction yarns.

44. The multilayer fabric of claim 39, wherein the machine direction yarns in each of said paired machine direction yarns in one of said first and second layers having a greater diameter than the diameter of the machine direction yarns in each of the paired machine direction yarns in the other of said first and second layers, said cross-machine-direction yarns being of a different diameter than the diameter of said machine direction yarns in said first and second layers.

45. The multilayer fabric of claim 39, having at least a 25% projected open area in each of said first and second layers.

46. The multilayer fabric of claim 39, wherein said cross-machine-direction yarns have a four pick repeat.

47. The multilayer fabric of claim 39, wherein said plurality of cross-machine-direction yarns include single cross-machine-direction yarns extending in the cross-machine direction and being spaced apart in the machine direction.

48. The multilayer fabric of claim 39, wherein said plurality of cross-machine-direction yarns are arranged in pairs of contiguous yarns, each pair of cross-machine-direction yarns being spaced apart in the machine direction from adjacent pairs of such cross-machine-direction yarns.

49. A multilayer woven fabric for use in a dryer section of a papermaking machine, said fabric including first and second layers, each layer including a plurality of pairs of machine direction yarns; the yarns in each pair of yarns being contiguous to each other, each pair of machine direction yarns in said first layer being spaced-apart from adjacent pairs of machine direction yarns in a cross-machine-direction to provide a desired projected open area in said first layer; the pairs of machine direction yarns in said second layer being spaced apart from adjacent pairs of machine direction yarns in the cross-machine-direction to provide a desired projected open area in said second layer, each pair of machine direction yarns in said first layer being in substantially vertically stacked alignment with a corresponding pair of machine direction yarns in said second layer and a plurality of cross-machine-direction yarns being spaced apart in the machine-direction and being interwoven with the pairs of machine direction yarns in said first and second layers to bind together the paired machine direction yarns in said first layer and the paired machine direction yarns in the second layer to establish and maintain each pair of machine direction yarns in said first layer in a substantially vertically stacked relationship with a corresponding pair of machine direction yarns in the second layer to maintain a desired open area through said first and second layers of said fabric, said fabric further including a resinous, embossing layer adhered to said fabric and including an upper surface for contacting a fibrous web being transported through said dryer section.

50. The multilayer fabric of claim 49, wherein said dryer section is a through air dryer section.
